(19) United States
(12) Patent Application Publication
(10) Pub. No.: US 2023/0228400 A1
(43) Pub. Date: Jul. 20, 2023

(54) INDOOR ILLUMINATION DEVICE FOR VEHICLE

(71) Applicant: HONDA MOTOR CO., LTD., Tokyo (JP)

(72) Inventors: Shuto Yoshiuchi, Tokyo (JP); Yoshitomo Oka, Tokyo (JP); Makoto Ohta, Tokyo (JP); Masakazu Okada, Tokyo (JP); Mai Nagasawa, Tokyo (JP); Tomoyo Futakawame, Tokyo (JP); Tomoo Ito, Tokyo (JP); Hiroki Taniguchi, Tokyo (JP); Yuichiro Imaizumi, Tokyo (JP); Miki Saito, Gunma (JP)

(21) Appl. No.: 18/096,036

(22) Filed: Jan. 12, 2023

(30) Foreign Application Priority Data
Jan. 18, 2022 (JP) 2022-005753

(51) Int. Cl. F21V 7/00; B60Q 3/54; B60Q 3/60

(52) U.S. Cl. CPC F21V 7/0016; B60Q 3/54; B60Q 3/60

(57) ABSTRACT

An indoor illumination device includes a compartment-side ceiling member, a lighting body support base, a direct illumination lighting body, and an indirect illumination lighting body. The lighting body support base is attached to the compartment-side ceiling member. The direct illumination lighting body is supported by a lighting body support base such that an illumination section of direct illumination lighting body is disposed below the compartment-side ceiling member and direct light is radiated into the passenger compartment. The indirect illumination lighting body is supported by a lighting body support base such that an illumination section of the indirect illumination lighting body is disposed above the compartment-side ceiling member and reflected light is radiated into the passenger compartment. The lighting body support base extends in a vehicle forward/rearward direction at an outer side portion of the ceiling section in the passenger compartment in a vehicle width direction.

### CROSS-REFERENCE TO RELATED APPLICATION

Priority is claimed on Japanese Patent Application No. 2022-005753, filed Jan. 18, 2022, the content of which is incorporated herein by reference.

### BACKGROUND OF THE INVENTION

### Field of the Invention

The present invention relates to an indoor illumination device for a vehicle.

### Description of Related Art

As an indoor illumination device for a vehicle, indirect illumination in which light from a lighting body is not directly radiated into a passenger compartment but is irradiated to other members and distributed as indirect light in the passenger compartment is known (for example, see Japanese Unexamined Patent Application, First Publication No. 2008-162349).

In the indoor illumination device disclosed in Japanese Unexamined Patent Application, First Publication No. 2008-162349, a light shielding member is attached to a lower surface of a roof lining with a gap, and an indirect illumination lighting body configured to radiate light to the lower surface of the roof lining is attached to an upper side of the light shielding member. The light radiated to the lower surface of the roof lining passes through a gap between the light shielding member and the roof lining and is distributed in the passenger compartment as indirect light.

### SUMMARY OF THE INVENTION

In the above-mentioned indoor illumination device, an indirect illumination lighting body is attached to a compartment-side ceiling member (roof lining) via a dedicated support base (light shielding member). Conventionally, the direct illumination lighting body configured to radiate direct light to a desired area in the passenger compartment is attached to a ceiling section in the passenger compartment. For this reason, when the above-mentioned indoor illumination device including the indirect illumination lighting body is employed, a large number of illumination lighting bodies are attached to the compartment-side ceiling member, and thus the number of support bases configured to install each of the illumination lighting bodies at the compartment-side ceiling member increases. As a result, the number of parts configured to install the illumination lighting body increases, and assembly man-hours also increase.

An aspect of the present invention is directed to providing an indoor illumination device for a vehicle capable of obtaining radiation of light due to direct light of a region below a side portion in a passenger compartment and distribution of soft light into the passenger compartment due to indirect light while suppressing an increase in the number of parts or an increase in assembly man-hours in order to install an illumination lighting body.

An indoor illumination device for a vehicle according to the present invention employs the following configuration.

(1) An indoor illumination device for a vehicle according to the present invention includes a compartment-side ceiling member facing an inside of a passenger compartment; a lighting body support base attached to the compartment-side ceiling member; a direct illumination lighting body supported by the lighting body support base such that an illumination section of the direct illumination lighting body is disposed below the compartment-side ceiling member and direct light is radiated into the passenger compartment; and an indirect illumination lighting body supported by the lighting body support base such that an illumination section of the indirect illumination lighting body is disposed above the compartment-side ceiling member and reflected light is radiated into the passenger compartment, the lighting body support base extends in a vehicle forward/rearward direction at an outer side portion of a ceiling section in the passenger compartment in a vehicle width direction.

According to the configuration of the aspect of the above-mentioned (1), the direct illumination lighting body supported by the lighting body support base at the outer side portion of the ceiling section of the passenger compartment in the vehicle width direction can brightly illuminate a foot step of an occupant getting on/off part of a side portion of the vehicle. In addition, the indirect illumination lighting body supported by the same lighting body support base can distribute the soft indirect light in the passenger compartment.

(2) In the aspect of the above-mentioned (1), the lighting body support base may extend in the vehicle width direction at a front portion and a rear portion of the ceiling section in the vehicle forward/rearward direction in the passenger compartment.

In the case of the aspect of the above-mentioned (2), both in front of and behind the ceiling section in the passenger compartment, it is possible to obtain radiation of the direct light and distribution of the indirect light by the direct illumination lighting body and the indirect illumination lighting body supported by the common lighting body support base.

(3) In the aspect of the above-mentioned (1) or (2), an opening for a sunroof may be provided in the ceiling section of the vehicle, and the lighting body support base may extend along a circumferential edge portion of the opening for the sunroof.

In the case of the aspect of the above-mentioned (3), it is easy for an occupant to see a position of the opening for a sunroof by turning on the direct illumination lighting body or the indirect illumination lighting body. In addition, in particular, when the occupant looks up toward the sky through the opening for a sunroof by turning on the indirect illumination lighting body at night, the night sky is seen in a state in which the circumferential edge portion of the opening for a sunroof is softly illuminated, and it is possible to provide a visual added value to the occupant.

(4) In the aspect of any one of the above-mentioned (1) to (3), the lighting body support base may be fixed to an upper surface of the compartment-side ceiling member, and the direct illumination lighting body may be fixed to the lighting body support base from below the compartment-side ceiling member while having the compartment-side ceiling member sandwiched therebetween.

In the case of the aspect of the above-mentioned (4), since the direct illumination lighting body is fixed to the lighting body support base while interposing the compartment-side ceiling member from the lower surface side of the compartment-side ceiling member, the lighting body support base member is not seen from below the compartment-side ceiling member (from the occupant in the passenger compartment). For this reason, the appearance from the inside of the passenger compartment becomes good.

(5) In the aspect of any one of the above-mentioned (1) to (4), the lighting body support base may include a convex portion protruding upward with respect to a fixing part fixed to an upper surface of the compartment-side ceiling member, and the indirect illumination lighting body may be disposed on an apex surface of the convex portion of the lighting body support base.

In the case of the aspect of the above-mentioned (5), the indirect illumination lighting body is disposed to be sufficiently separated from the direct illumination lighting body because of the convex portion of the lighting body support base. For this reason, it is possible to suppress the light from the indirect illumination lighting body from leaking around the direct illumination lighting body. Accordingly, when the indirect illumination lighting body and the direct illumination lighting body are simultaneously turned on at night or the like, a difference between quantities of light of an irradiation area of the indirect illumination lighting body and an irradiation area of the direct illumination lighting body becomes clear, and the appearance in the passenger compartment becomes good.

In the indoor illumination device for a vehicle according to the present invention, the lighting body support base that supports the direct illumination lighting body and the indirect illumination lighting body is attached to the compartment-side ceiling member so as to extend in the vehicle forward/rearward direction from an outer side portion of the ceiling section in the passenger compartment in the vehicle width direction. For this reason, it is possible to obtain radiation of the light by the direct light and distribution of the soft light into passenger compartment by the indirect light in a lower side region in the passenger compartment (the foot step of the occupant getting-on/off part) while suppressing an increase in the number of parts and an increase in assembly man-hours in order to install the illumination lighting body.

### BRIEF DESCRIPTION OF THE DRAWINGS

FIG. 1 is a perspective view of a vehicle of an embodiment.

FIG. 2 is a cross-sectional view along line II-II of FIG. 1 of the vehicle of the embodiment.

FIG. 3 is a perspective view of a vehicle of a variant.

FIG. 4 is a cross-sectional view along line IV-IV of FIG. 3 of the vehicle of the variant.

### DETAILED DESCRIPTION OF THE INVENTION

Hereinafter, an embodiment of the present invention will be described with reference to the accompanying drawings.

Further, in the following description, forward, rearward, upward, downward, leftward and rightward in the following description are the same as directions in a vehicle described below unless the context clearly indicates otherwise. In addition, in appropriate places in the drawings, an arrow UP indicates an upward direction with respect to the vehicle, an arrow FR indicates a forward direction with respect to the vehicle, and an arrow LH indicates a leftward direction with respect to the vehicle. In addition, in the following embodiment and variant, the same components are designated by the same reference signs.

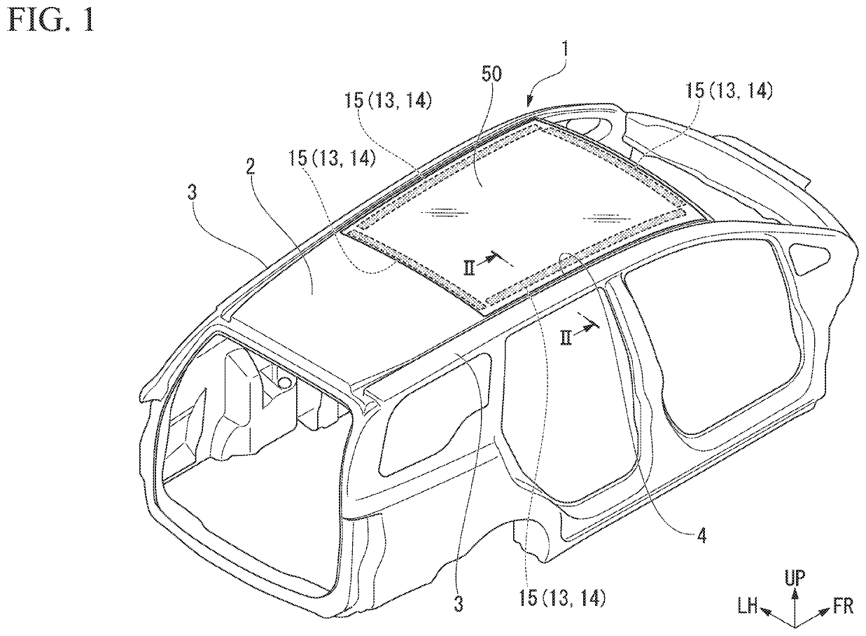

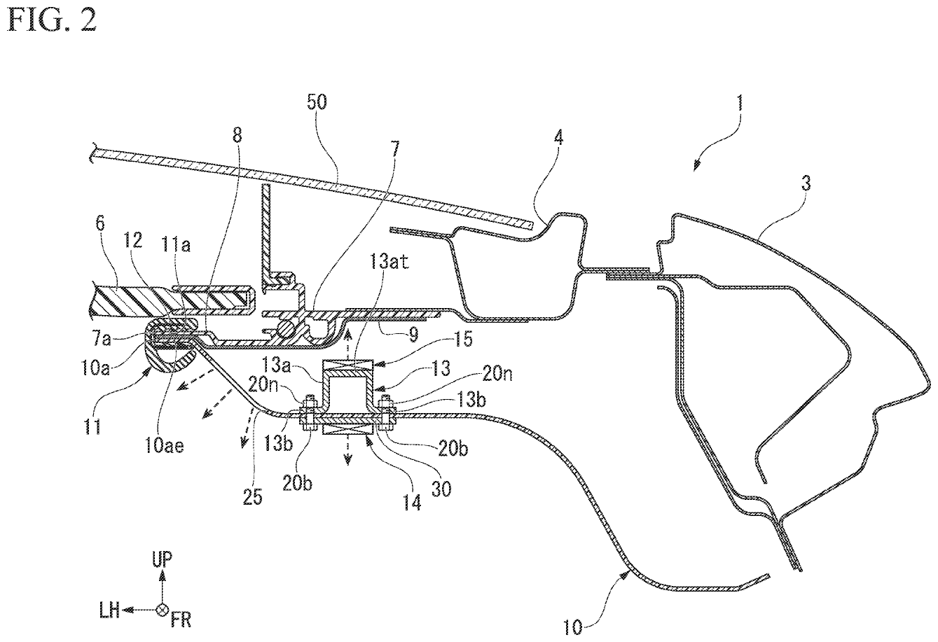

FIG. 1 is a view showing a vehicle 1 of the embodiment from above a right rear portion. FIG. 2 is a cross-sectional view along line II-II of the vehicle 1 of FIG. 1.

In the drawings, reference sign 2 designates a roof panel that is a ceiling member on an outer side of the vehicle, and reference sign 3 designates roof side rails extending in the vehicle forward/rearward direction at left and right sides of a ceiling section of the vehicle 1. An opening 4 for a sunroof having a substantially rectangular shape is provided in a central region close to a front portion of the roof panel 2. A roof glass 50 is attached to the opening 4 for a sunroof.

As shown in FIG. 2, a roof lining 10 that is a compartment-side ceiling member facing the inside of a passenger compartment is attached to a ceiling section in the passenger compartment. In addition, a shade guide frame 7 configured to guide a roof shade 6 that is movable forward and rearward is installed at a position below the opening 4 for a sunroof inside the passenger compartment. The shade guide frame 7 is a rectangular frame member slightly smaller than the opening 4 for a sunroof. A flange portion 8 extending substantially horizontally toward an inner side of the opening 7a is provided on left and right side edge portions of a rectangular opening 7a inside the shade guide frame 7. A sheet-shaped interior member 9 (reflecting member) is adhered to lower surfaces of the left and right side edge portions of the shade guide frame 7 including the flange portion 8.

The roof lining 10 has an opening 10a with substantially the same shape as the opening 7a at a position corresponding to the opening 7a of the shade guide frame 7. A side edge portion of the roof lining 10 on an outer side in a vehicle width direction is supported by a frame member on a side of the ceiling section, a side edge portion of the opening 10a is inclined inward and upward in the vehicle width direction, and a terminal section 10ae is overlapped on the shade guide frame 7 on the side of a lower surface of the flange portion 8. In the case of the embodiment, the terminal section 10ae is overlapped on the lower surface of the flange portion 8 with the interior member 9 sandwiched therebetween. The flange portion 8, the interior member 9 and the terminal section 10ae of the roof lining 10 are covered with a resin molding 11 elongated in the vehicle forward/rearward direction. The resin molding 11 has a sandwiching groove 11a that sandwiches the flange portion 8, the interior member 9 and the terminal section 10ae of the roof lining 10, and a core bar 12 configured to apply a reaction force to a portion of the sandwiching groove 11a is embedded in an outer side of the sandwiching groove 11a. The terminal section 10ae of the roof lining 10 is fixed to the shade guide frame 7 by being sandwiched in the sandwiching groove 11a of the resin molding 11 together with the flange portion 8 and the interior member 9.

A direct illumination lighting body 14 and an indirect illumination lighting body 15 are attached to the side edge portion of the opening 10a of the roof lining 10 via a lighting body support base 13. The indoor illumination device of the embodiment is constituted by the roof lining 10, the lighting body support base 13, the direct illumination lighting body 14 and the indirect illumination lighting body 15 as main elements.

The lighting body support base 13 is a long member formed of a resin or a metal in which a hat-shaped cross-sectional shape is continuous in a longitudinal direction. More specifically, the lighting body support base 13 has a pair of flange portions 13b continuously expanding outward from a lower end of a base main body section 13a having a C-shaped cross section that opens downward. The lighting body support base 13 has a cross-sectional shape that is continuous in a longitudinal direction. The flange portions 13b are overlapped on the upper surface of the roof lining 10, or fixed to the upper surface of the roof lining 10 by adhesion or a bolt 20b and a nut 20n. The base main body section 13a protrudes upward with respect to the flange portions 13b fixed to the roof lining 10. The lighting body support base 13 is fixed to the upper surface of the roof lining 10 so as to extend forward and rearward in the vehicle at both side portions of the ceiling section in the passenger compartment in the vehicle width direction.

In the embodiment, the flange portions 13b constitute a fixing part of the lighting body support base 13, and the base main body section 13a constitutes a convex portion of the lighting body support base 13.

The direct illumination lighting body 14 is overlapped on the lower surface of the roof lining 10 and fixed to the lighting body support base 13 by the bolt 20b and the nut 20n at the side of the upper surface of the roof lining 10 so as to sandwich the roof lining 10 therebetween. More specifically, the direct illumination lighting body 14 is integrally fixed to a support plate 30 having an external form slightly greater than that of the direct illumination lighting body 14 by adhesion or the like, and an upper surface side of the support plate 30 is directly overlapped on the lower surface of the roof lining 10. Then, the support plate 30 has a circumferential edge portion fixed to the lighting body support base 13 on the roof lining 10 by the bolt 20b and the nut 20n in this state. In addition, the direct illumination lighting body 14 is constituted by, for example, a plurality of LED chips. The direct illumination lighting body 14 is disposed on the lower surface of the roof lining 10 such that the illumination section is directed downward. Accordingly, direct light of the direct illumination lighting body 14 is radiated onto, for example, a floor surface or the like of an occupant getting on/off part in the passenger compartment.

Further, the illumination section of the direct illumination lighting body 14 may be disposed in the entire extension region of the lighting body support base 13 or may be disposed as a spot in part of the extension region of the lighting body support base 13.

The indirect illumination lighting body 15 is fixed to an apex surface 13 at of the lighting body support base 13 by adhesion, a screw clamp, or the like, at above the roof lining 10. The indirect illumination lighting body 15 is constituted by, for example, a plurality of LED chips. The indirect illumination lighting body 15 is disposed such that the illumination section faces the interior member 9 on the upper side. The illumination section of the indirect illumination lighting body 15 is disposed in the substantially entire extension region of the lighting body support base 13.

An opening section 25 configured to distribute the indirect light from the indirect illumination lighting body 15 into the passenger compartment is provided between the installation section of the lighting body support base 13 and the side edge portion of the opening 10a of the roof lining 10. The opening section 25 is formed in an inclination region of the roof lining 10 inclined inward and upward in the vehicle width direction. The light emitted from the illumination section of the indirect illumination lighting body 15 is radiated to the interior member 9, and the light abutting the interior member 9 is distributed in the passenger compartment from the opening section 25 as the indirect light.

In addition, in the vehicle of the embodiment, the direct illumination lighting body 14 and the indirect illumination lighting body 15 are also attached to not only the left and right side edge portions of the opening 10a of the roof lining 10 but also the front and rear side edge portions of the opening 10a via the lighting body support base 13. The lighting body support base 13 attached to the front and rear side edge portions of the opening 10a extends in the vehicle width direction. Similar to the above-mentioned side edge portion, the direct illumination lighting body 14 and the indirect illumination lighting body 15 are supported by the lighting body support base 13 attached to the front and rear side edge portions of the opening 10a.

Here, the vehicle interior illumination device of the embodiment has an all lighting mode of simultaneously lighting the direct illumination lighting body 14 and the indirect illumination lighting body 15 supported by each of the lighting body support bases 13, a direct illumination mode of lighting the direct illumination lighting body 14 only, and an indirect illumination mode of lighting the indirect illumination lighting body 15 only. Each lighting mode of those can be switched by an operation or the like of a switch (not shown).

As described above, in the vehicle interior illumination device of the embodiment, the lighting body support base 13 that supports the direct illumination lighting body 14 and the indirect illumination lighting body 15 extends in the vehicle forward/rearward direction at an outer side portion of the ceiling section in the passenger compartment. Then, the direct illumination lighting body 14 is disposed below the roof lining 10 and radiates the direct light into the passenger compartment, and the indirect illumination lighting body 15 is disposed above the roof lining 10 and distributes the light reflected by the interior member 9 into the passenger compartment as the indirect light.

For this reason, when the vehicle interior illumination device of the embodiment is employed, it is possible to obtain radiation of light by direct light in a lower side region in the passenger compartment (a foot step of the occupant getting on/off part) and distribution of soft light into the passenger compartment by the indirect light while suppressing an increase in the number of parts and an increase in assembly man-hours in order to install the illumination lighting body.

In addition, in the vehicle interior illumination device of the embodiment, the lighting body support base 13 extends also in the vehicle width direction at the front portion and the rear portion of the ceiling section in the vehicle forward/rearward direction, and the direct illumination lighting body 14 and the indirect illumination lighting body 15 are attached to the lighting body support base 13 as same as the lighting body support base 13 on the outer side in the vehicle width direction. For this reason, it is possible to obtain radiation of the direct light and distribution of the indirect light by the direct illumination lighting body 14 and the indirect illumination lighting body 15 supported by the common lighting body support base 13 even at front and rear of the ceiling section in the passenger compartment.

Further, in the vehicle interior illumination device of the embodiment, the lighting body support base 13 is disposed on the circumferential edge portion of the opening 4 for a sunroof provided on the ceiling section of the vehicle so as to extend along the circumferential edge portion of the opening 4 for a sunroof. For this reason, it is easy for an occupant to see the position of the opening 4 for a sunroof by turning on the direct illumination lighting body 14 or the indirect illumination lighting body 15. In addition, by turning on the indirect illumination lighting body 15 at night, when the occupant looks up at the sky through the opening 4 for a sunroof, the night sky is seen in a state in which the circumferential edge portion of the opening 4 for a sunroof glows softly, and it is possible to provide a visual added value to the occupant.

In addition, in the vehicle interior illumination device of the embodiment, the lighting body support base 13 is fixed to the upper surface of the roof lining 10, and the direct illumination lighting body 14 is fixed to the lighting body support base 13 from below the roof lining 10 while having the roof lining 10 sandwiched therebetween. For this reason, the lighting body support base 13 is no longer visible from below the roof lining 10 (from the inside of the passenger compartment). Accordingly, when the configuration is employed, appearance from the passenger compartment becomes good.

In addition, in the vehicle interior illumination device of the embodiment, the lighting body support base 13 includes the convex portion (the base main body section 13a) protruding upward from the flange portions 13b, and the indirect illumination lighting body 15 is disposed on the apex surface 13 at of the convex portion (the base main body section 13a). For this reason, the indirect illumination lighting body 15 is disposed at a position sufficiently separated from the direct illumination lighting body 14 toward the upper side. Accordingly, it is possible to suppress the light from the indirect illumination lighting body 15 from leaking around the direct illumination lighting body 14.

Accordingly, in the case in which the vehicle interior illumination device of the embodiment is employed, when the indirect illumination lighting body 15 and the direct illumination lighting body 14 are simultaneously turned on at night or the like, a difference between the quantities of light of the irradiation area of the indirect illumination lighting body 15 and the irradiation area of the direct illumination lighting body 14 becomes clear, and the appearance in the passenger compartment becomes good.

In addition, in the vehicle interior illumination device of the embodiment, the lighting body support base 13 is attached to the roof lining 10, and the opening section 25 configured to distribute the indirect light in the passenger compartment is provided at an inner region of the installation section of the lighting body support base 13 in the vehicle width direction among the roof lining 10. For this reason, the indirect light can be distributed in the passenger compartment by the simple configuration. In addition, since the conventional roof lining 10 can be easily used, it can be manufactured at low cost.

Further, in the vehicle interior illumination device of the embodiment, the interior member 9 is attached to a position facing the illumination section of the indirect illumination lighting body 15. For this reason, the indirect light distributed in the passenger compartment can be appropriately set by properly selecting a material, a surface shape, color, or the like, of the interior member 9.

In addition, in the vehicle interior illumination device of the embodiment, the terminal section 10ae of the roof lining 10 on the side of the opening 10a is sandwiched by the sandwiching groove 11a of the resin molding 11 together with the flange portion 8 of the shade guide frame 7 that is a sunroof-constituting member and the end portion of the interior member 9. For this reason, according to the simple configuration, the terminal section 10ae of the roof lining 10 and the end portion of the interior member 9 can be fixed to the sunroof-constituting member.

Further, the present invention is not limited to the embodiment, and various design changes may be made without departing from the scope of the present invention.

For example, while the opening 4 for a sunroof is provided in the roof panel 2 of the vehicle and the roof glass 50 is attached to the opening 4 for a sunroof in the embodiment, the indoor illumination device according to the present invention can also be applied to the vehicle that does not include such a sunroof.

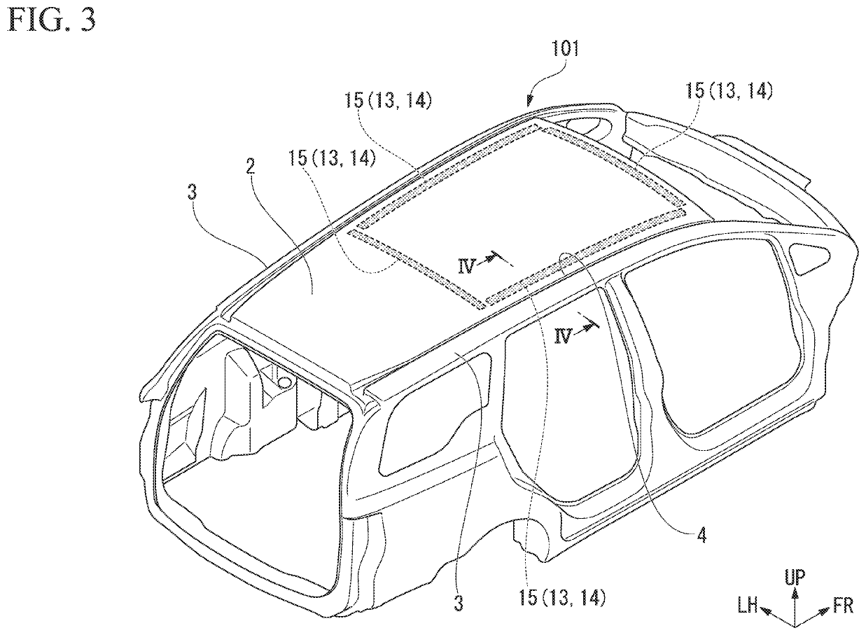

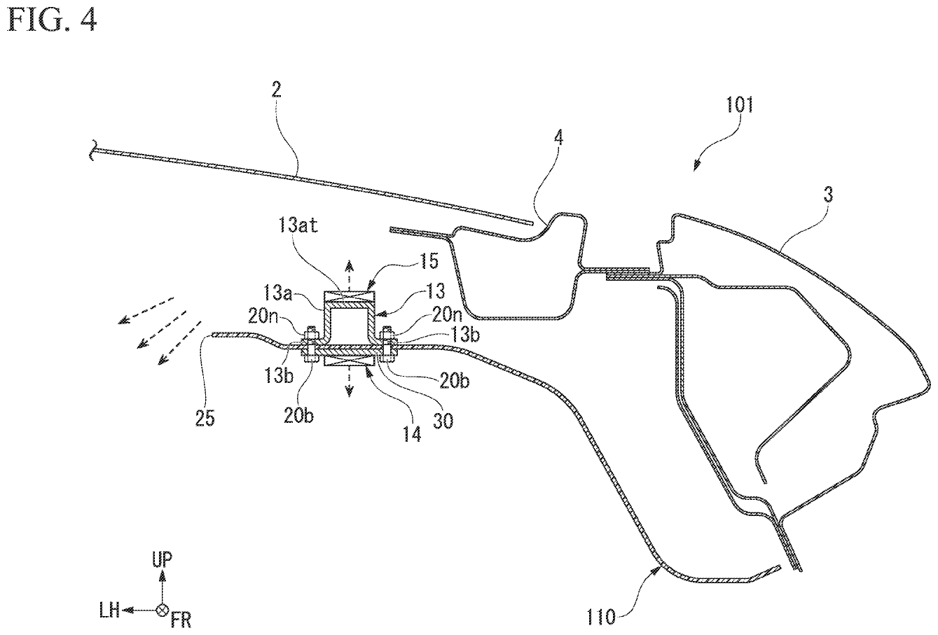

FIG. 3 is the same perspective view as FIG. 1 showing a variant in which the indoor illumination device is applied to the vehicle 101 that does not include the sunroof, and FIG. 4 is a cross-sectional view along line IV-IV of FIG. 3.

In the variant, while sunroof-constituting parts such as a shade guide frame and the like are not disposed inside the passenger compartment, like the above-mentioned embodiment, the lighting body support base 13 is attached to an upper surface side of a roof lining 110, the direct illumination lighting body 14 is fixed to the lighting body support base 13 from a lower surface side of the roof lining 110, and the indirect illumination lighting body 15 is fixed to the apex surface 13 at of the lighting body support base 13.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An indoor illumination device for a vehicle comprising:
a compartment-side ceiling member facing an inside of a passenger compartment;
a lighting body support base attached to the compartment-side ceiling member;
a direct illumination lighting body supported by the lighting body support base such that an illumination section of the direct illumination lighting body is disposed below the compartment-side ceiling member and direct light is radiated into the passenger compartment; and
an indirect illumination lighting body supported by the lighting body support base such that an illumination section of the indirect illumination lighting body is disposed above the compartment-side ceiling member and reflected light is radiated into the passenger compartment,
wherein the lighting body support base extends in a vehicle forward/rearward direction at an outer side portion of a ceiling section in the passenger compartment in a vehicle width direction.

2. The indoor illumination device for a vehicle according to claim 1, wherein the lighting body support base extends in the vehicle width direction at a front portion and a rear portion of the ceiling section in the vehicle forward/rearward direction in the passenger compartment.

3. The indoor illumination device for a vehicle according to claim 1, wherein an opening for a sunroof is provided in the ceiling section of the vehicle, and
the lighting body support base extends along a circumferential edge portion of the opening for the sunroof.

4. The indoor illumination device for a vehicle according to claim 1, wherein the lighting body support base is fixed to an upper surface of the compartment-side ceiling member, and
the direct illumination lighting body is fixed to the lighting body support base from below the compartment-side ceiling member while having the compartment-side ceiling member sandwiched therebetween.

5. The indoor illumination device for a vehicle according to claim 1, wherein the lighting body support base includes a convex portion protruding upward with respect to a fixing part fixed to an upper surface of the compartment-side ceiling member, and
the indirect illumination lighting body is disposed on an apex surface of the convex portion of the lighting body support base.
